(19) United States
(12) Patent Application Publication
(10) Pub. No.: US 2016/0179627 A1
(43) Pub. Date: Jun. 23, 2016

(54) METHOD AND SYSTEM FOR CHECKPOINTING A GLOBAL STATE OF A DISTRIBUTED SYSTEM

(71) Applicant: NEC EUROPE LTD., Heidelberg (DE)

(72) Inventors: Maurizio Dusi, Gadesco Pieve Delmona (IT); Luca Fiori, San Giorgio a Cremano (IT); Francesco Gringoli, Brescia (IT)

(73) Assignee: NEC Europe Ltd., Heidelberg (DE)

(21) Appl. No.: 14/908,131

(22) PCT Filed: Jul. 30, 2013
(86) PCT No.: PCT/EP2013/066040

§ 371 Date: Jan. 28, 2016

(51) Int. Cl. G06F 11/14

(52) U.S. Cl. CPC G06F 11/1451; G06F 11/1469; G06F 2201/805; G06F 2201/84

(57) ABSTRACT

A method for check pointing a global state of a distributed system with one or more distributed applications organized in a directed acyclic graph topology includes, upon receiving a marker in an active input channel of a first task application, putting an active input channel on hold, performing check pointing by saving an internal state of the first task application when all input channels have received a marker and are put on hold, forwarding the marker via all output channels of the first task application to at least one other task application of the one or more task applications, and reactivating all input channels of the first task application, wherein the global state is a union of all internal states of the task applications after each of the one or more task applications has been check pointed.

### CROSS REFERENCE TO RELATED APPLICATIONS

This application is a U.S. National Stage Application under 35 U.S.C. §371 of International Application No. PCT/EP2013/066040 filed on Jul. 30, 2013.The International Application was published in English on Feb. 5, 2015 as WO 2015/014394 A1 under PCT Article 21(2).

### FIELD

The present invention relates to a method for check pointing a global state of a distributed system with one or more distributed applications, wherein the one or more distributed applications are organized in a directed acyclic graph topology, and wherein sources providing data to one or more tasks each having one or more input channels and one or more output channels for exchanging processed data between tasks. The present invention further relates to a distributed system with one or more distributed applications on a plurality of nodes.

### BACKGROUND

Check pointing techniques are used in distributed computing systems for recording a consistent global state of an asynchronous system. When an application running on such a system is composed of several processes or tasks each of them running in parallel and exchanging messages between each other through connecting channels check pointing takes a snap shot of each process at a given point in time in terms of which messages the process is elaborating and the states of its internal variables, for example the value of some counters and takes a snap shot of each channel in terms of the messages sent but not yet received. The global state is given by the union of the internal state of each process and of all the channels. The execution of the application can be resumed from the latest snap shot in case of a system failure.

The time needed to complete the check pointing operation is in particular important in real-time applications having usually a high message rate. Messages coming into the system cannot be controlled but must be processed.

Conventional check pointing techniques have to serialize the state of each channel resulting in a high message rate. One of the drawbacks is therefore that the operation of serializing the state of each channel heavily slows down the entire execution which might also lead to violate real-time requirements.

One of the conventional techniques for check pointing of applications running on distributed computing systems is based on the so-called Chandy-Lamport algorithm based on the non-patent literature of K. Mani Chandy and Leslie Lamport. 1985, “Distributed snapshots: determining global states of distributed systems”,ACM Trans. Comput. Syst. 3, 1 (February 1985), 63-75. DOI=10.1145/214451.214456, http://doi.acm.org/10.1145/214451.214456. The algorithm uses marker messages and ensures that a consistent global state of a distributed computing system can be saved under the following assumptions:
1. There are no failures and all messages arrive intact and only once.
2. The communication channels are unidirectional and First-In-First-Out (FIFO) ordered.
3. There is a communication path between any two processes in the system
4. Any process may initiate the snapshot algorithm.
5. Each process in the system records its local state and the state of its incoming channels.

The Chandy-Lamport algorithm has, inter alia, the drawback that it requires to save for each process both its internal state and the state of all its input channels. Saving the state of the channels requires to (de)serialize messages slowing down the execution and systems with high message rates, which is in particular typical in stream applications.

### SUMMARY

In an embodiment, the present invention provides a method for check pointing a global state of a distributed system with one or more distributed applications organized in a directed acyclic graph topology, wherein one or more source applications provide data to one or more task applications each having one or more input channels and one or more output channels for exchanging processed data with others of the one or more task applications, wherein at least one of the one or more task applications processes data received on its input channels sends processed data out on one or more of its output channels to at least one other of the one or more task applications, and wherein one or more destinations collect processed data. The method includes, upon receiving a marker in an active input channel of a first task application, putting the input channel on hold; performing check pointing by saving an internal state of the first task application when all input channels have received a marker and are on hold; forwarding the marker via all output channels of the first task application to at least one other task application of the one or more task applications; and reactivating the input channels of the first task application, wherein the global state is a union of all internal states of the task applications after each of the one or more task applications has been check pointed.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 depicts a system according to a first embodiment of the present invention; and

FIG. 2 depicts a flow diagram for a method according to a second embodiment of the present invention.

### DETAILED DESCRIPTION

According to an embodiment, the present invention provides a method for check pointing a global state of a system and a system which enables a fast and reliable execution even with a high message rate.

According to an embodiment, the present invention provides a method for check pointing a global state of a system and a system which saves computing and memory resources.

According to an embodiment, the present invention provides a method for check pointing a global state of a system and a system which is more flexible in terms of parallel execution of applications when check pointing.

According to an embodiment, a method is provided for check pointing a global state of a distributed system with one or more distributed applications, wherein the one or more distributed applications are organized in a directed acyclic graph topology, and wherein sources providing data to one or more tasks each having one or more input channels and one or more output channels for exchanging processed data between tasks and wherein a task processes data received on its input channels and wherein processed data is sent out on one or more of its output channels to other tasks, and wherein one or more destinations collect processed data.

According to an embodiment, a method is characterized by the steps of:
a) Upon receiving of a marker in an active input channel of a task the active input channel is put on hold,
b) Perform check pointing by saving the internal state of the task when all input channels are on hold,
c) Forward the marker via all output channels of the task to other tasks, and
d) Reactive all the input channels of the task,
   wherein the global state is the union of all internal states of the tasks after each task has been check pointed.

According to an embodiment, a distributed system with one or more distributed applications on a plurality of nodes is defined, wherein a system with one or more distributed applications on a plurality of nodes wherein the nodes are operable to execute one or more distributed applications which are organized in a directed acyclic graph topology, and wherein sources providing data to one or more tasks each having one or more input channels and one or more output channels for exchanging processed data between tasks and wherein a task processes data received on its input channels and wherein processed data is sent out on one or more of its output channels to other tasks, and wherein one or more destinations collect processed data.

According to an embodiment, a system is characterized in that
a) put an active input channel of a task running on the node upon receiving of a marker in the active input channel on hold,
b) perform check pointing by saving the internal state of the task when all input channels are on hold,
c) forward the marker via all output channels of the task to other tasks, and
d) to reactivate all the input channels of the task,
   wherein the global state is the union of all internal states of the tasks after each task has been check pointed.

According to an embodiment of the invention it has been recognized that serializing and saving messages on the channels is not required to obtain a consistent global state.

According to an embodiment of the invention it has been further recognized that offloading the process from serializing the messages on its channels saves computing and memory resources.

According to an embodiment of the invention it has been further recognized that a continued execution of the applications is enabled while check pointing takes place on a task.

According to an embodiment of the invention it has been further recognized that there is no need to save the state of the channels.

According to a preferred embodiment a marker is provided by the one or more sources downstream along the processes of the directed acyclic graph topology. This enables an easy implementation with the need to generate further markers by intermediate nodes.

According to a further preferred embodiment the input and output channels are unidirectional and/or messages in these channels are ordered according to the first-in-first-out principle. This allows an easy handling of messages in channels.

According to a further preferred embodiment upon receiving further messages in input channels on hold, these further messages are queued until the input channel is reactivated. By queuing the messages reliable snap shot of the state of the channel is provided without losing messages to be processed in the future upon reactivation.

According to a further preferred embodiment step b) and c) are swapped. This enables forwarding the marker to downstream tasks without having to wait for the checkpointing operation to complete. Thus, parallelization is enabled.

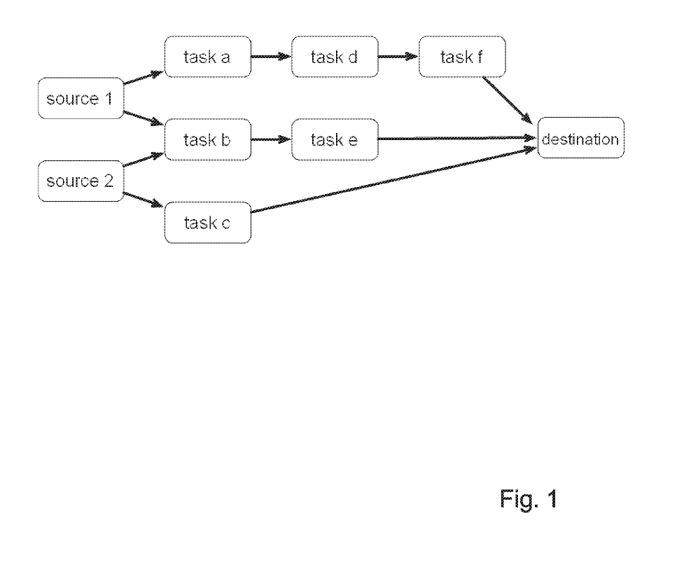

FIG. 1 shows a system according to a first embodiment of the present invention.

In FIG. 1 distributed applications with a direct acyclic graph DAG topology are shown. Sources source 1, source 2 inject data into the system and intermediate tasks a, b, c, d, e, f process the data. A destination collects the process data by the tasks task a-f and eventually exports it.

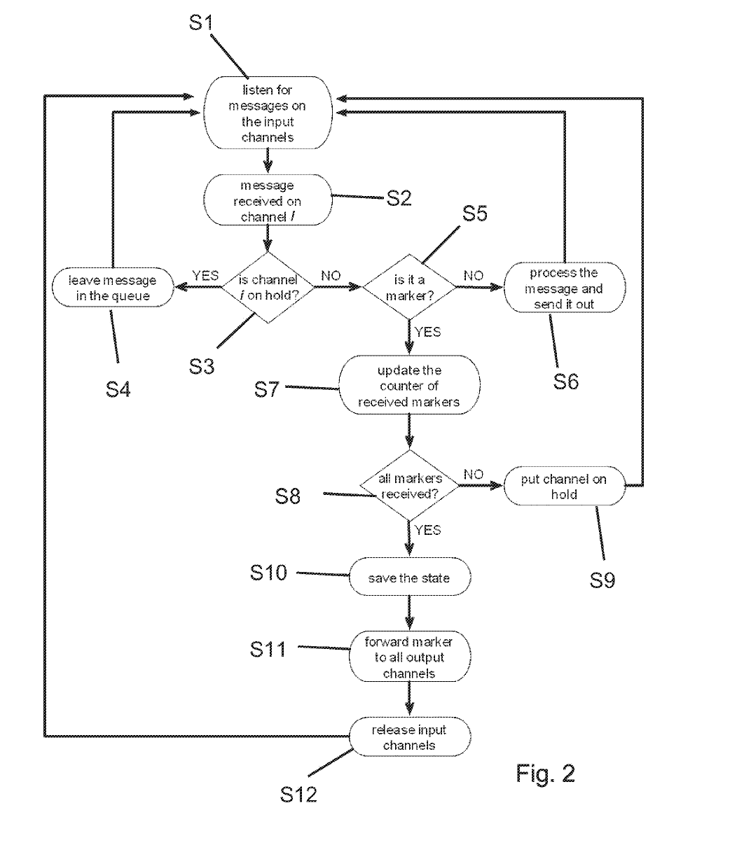

FIG. 2 shows a flow diagram for a method according to a second embodiment of the present invention.

In FIG. 2 a flow chart of an embodiment of the present invention is shown.

A process or task listens for messages on its input channels in a first step S1.

When a message is received on a channel i in a second step S2 it is determined in a third step S3 if this channel i is on hold.

If yes then in a fourth step S4 the message is queued in the input channel i and the steps S1-S3 are performed again.

If the channel i is not on hold then in a fifth step S5 it is checked whether the message received on channel i is a marker message.

If the received message is not a marker message then in a sixth step S6 the message is processed and sent out via one or more output channels and steps S1-S3 are performed again.

If the message received on channel i is a marker message then in a seventh step S7 a counter of received markers is updated, i.e. incremented by +1.

Then in a eighth step S8 it is checked if all markers from all input channels have been received.

If the counter of received markers is smaller than the number of input channels, then in a ninth step S9 the channel i is put on hold and steps S1-S3 are performed again.

If all markers have been received then in a tenth step S10 the state of the process is saved. After that the markers are forwarded to all output channels of a process in an eleventh step S11. In a final step S12 the input channels are released, i.e. are reactivated and steps S1-S3 are performed again. To parallelize operations, step S10 and S11 can be swapped.

In other words the action of saving the state of each process is postponed until the process receives a marker from all its input channels.

In summary, embodiments of the present invention enable check pointing of the state of an application which is composed of distributed processes exchanging messages in a DAG topology, wherein only the internal state of the processes is check pointed but not their channels. Further the present invention does not have to serialize and save messages on the channels.

Embodiments of the present invention have, inter alia, the following advantages: embodiments enable a fast check pointing even when the message rate for the messages exchange is high. A further advantage is that computing and memory resources are saved due to the offload of processes from serializing the messages on its channels. An even further advantage is that an execution of applications is enabled to continue while the snap shot respectively the check pointing takes place on a process or task.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method car check pointing a global state of a distributed system with one or more distributed applications organized in a directed acyclic graph topology, wherein one or more source applications provide data to one or more task applications each having one or more input channels and one or more output channels for exchanging processed data with others of the one or more task applications, wherein at least one of the one or more task applications processes data received on its input channels sends processed data out on one or more of its output channels to at least one other of the one or more task applications, and wherein one or more destinations collect processed data, the method comprising:
a) upon receiving a marker in an active input channel of a first task application, putting the input channel on hold,
b) performing check pointing by saving an internal state of the first task application when all input channels have received a marker and are on hold,
c) forwarding the marker via all output channels of the first task application to at least one other task application of the one or more task applications, and
d) reactivating the input channels of the first task application,
wherein the global state is a union of all internal states of the task applications after each of the one or more task applications has been check pointed.

2. The method according to claim 1, wherein a marker is provided by the one or more source applications downstream along the one or more task applications of the directed acyclic graph topology.

3. The method according to claim 1, wherein the input and output channels of the first task application are unidirectional and/or messages in these channels are ordered according to the first-in-first-out principle.

4. The method according to claim 1, wherein messages received in an input channels on hold are queued until the input channel on hold is reactivated.

5. The method according to claim 1, wherein steps b) occurs before step c).

6. A distributed system with one or more distributed applications on a plurality of nodes wherein the nodes are operable to execute one or more distributed applications which are organized in a directed acyclic graph topology, wherein one or more source applications provide data to one or more task applications each having one or more input channels and one or more output channels for exchanging processed data with others of the one or more task applications, wherein at least one of the one or more task applications processes data received on its input channels and sends processed data out on one or more of its output channels to at least one other of the one or more task applications, and wherein one or more destinations collect processed data, the system comprising:
a first node operable to:
a) put an active input channel of a first task application running on the node on hold upon receiving a marker in the input channel,
b) perform check pointing by saving the internal state of the first task application when all input channels have received a marker and are put on hold,
c) forward the marker via all output channels of the first task application to at least one task application of the other task applications, and
d) reactivate the input channels of the first task application,
wherein the global state is a union of all internal states of the task applications after each of the one or more task applications has been check pointed.
